(19) United States
(12) Patent Application Publication
(10) Pub. No.: US 2005/0099528 A1
(43) Pub. Date: May 12, 2005

(54) Mobile terminal device with a camera, illumination control method thereof and program for illumination control

(76) Inventors: Atsuo Soma, Hitachinaka (JP); Kenji Iida, Hitachinaka (JP); Satoru Matsumiya, Hitachinaka (JP); Toshio Hiraishi, Hitachinaka (JP); Hiroyuki Katsurai, Hitachinaka (JP)

Correspondence Address: MCDERMOTT, WILL & EMERY, 600 13th Street, N.W., Washington, DC, 20005-3096, US

(21) Appl. No.: 10/813,634

(22) Filed: Mar. 31, 2004

(30) Foreign Application Priority Data
Nov. 7, 2003 (JP) 2003-378483

(51) Int. Cl. H04N 5/222

(52) U.S. Cl. 348/370

(57) ABSTRACT

A mobile terminal device with a camera is provided which can secure emitted light brightness of a camera light unit and save power consumption of the device. During photographing, when the driving power of the camera light unit is increased, driving power for an illumination unit is decreased so that the increase of the total power consumption of the camera light unit and illumination unit can be minimized. In addition, the camera lamp unit and illumination unit are driven by respective driving circuits that share a power supply unit.

### BACKGROUND OF THE INVENTION

The present invention relates to a mobile terminal device with a camera, and more particularly to an illumination control technology therefor.

In recent years, attention has been paid to a mobile terminal device with a camera that has a camera illumination function so that photographing can be carried out at a dark location, in the mobile terminal devices with a camera such as a mobile phone and the like.

Prior art examples related to the present invention include Japanese Patent Laid-open No. 2003-158675 (patent document 1), Japanese Patent Laid-open No. 11-341322 (patent document 2) and Japanese Patent Laid-open No. 2001-159880 (patent document No. 3). Japanese Patent Laid-open No. 2003-158675 describes a light emitting control technology for the camera lamp unit for use in controlling light intensity in an imaging device in order to decrease noise caused by the light emitting unit (the camera lamp unit) for illuminating an object in an imaging device and improve design freedom. In this case, the light intensity is controlled by using a white LED (Light Emitting Diode) for the light emitting unit (a camera lamp unit), changing a driving current supplied to the white LED or changing the number of driven white LEDs. Japanese Patent Laid-open No. 11-341322 describes a control technology for power saving in a digital camera. In this technology, data writing to an IC card is started by depressing a shutter button, and electrical power supplied from a power supply for illuminating a liquid crystal display (LCD) is reduced to a level lower than the electrical power before the shutter button is depressed. In addition, when the data writing to the IC card is completed, the electrical power supplied for LCD backlight from the power supply is returned to the same level as that of the electrical power before the shutter button is depressed. Japanese Patent Laid-open No. 159880 describes a technology for making clear an image picked up with a camera in an information-processing device without an effect of battery power. In this technology, a brightness level of the backlight is decreased at the time of actuating the camera so as to minimize the lowering of battery voltage. At the same time, the contrast of the image is changed according to a change in brightness of the backlight.

Among the prior art examples, the technology described in Japanese Patent Laid-open No. 2003-158675 is configured such that an operation mode of the light emitting unit (the camera lamp unit) is changed over to an automatic light emitting mode and a light emitting prohibition mode by changing a driving current or the number of turned-on white LEDs in the light emitting unit. In this case, the operating state of the illumination unit (the backlight unit) is not changed in accordance with the state of the camera lamp unit. In addition, a technical concept pertaining to the driving circuit does not involve downsizing and cost reduction. In addition, the technology is to avoid wasteful power consumption by preventing light emission, from the white LEDs as the camera light unit, more than necessary and is not to minimize an increase in driving power for both the camera light unit and illumination unit (backlight unit) as a whole. Further, the technology described in Japanese Patent Laid-open No. 11-341322 is to reduce the power supplied to the LCD backlight unit (illumination unit) from the power supply at the time of data writing to the IC card after the depression of the shutter button in the digital camera. In addition, the technology described in Japanese Patent Laid-open No. 2001-159880 is to lower the brightness of the backlight unit in the information processing device at the time of actuating the camera in order to minimize the lowering of the battery voltage. In contrast, none of the technologies described above are to minimize the driving power of the entire illumination unit including the backlight unit (illumination unit) and camera light unit at the time of driving the camera light unit. In addition, these three technologies do not involve the concepts of downsizing and cost reduction for parts including a drive circuit or the entire device. In the device in which all the driving power is supplied from the battery, an increase in the driving may lead to shortening of time in which the battery can continuously be used without charging.

In view of the foregoing, the problems of the mobile terminal device with camera relating to the present invention are:
(1) to minimize an increase in the entire driving power for the camera lamp unit and the illumination unit (the backlight unit or front light unit) with intensity of the light generated in the camera lamp unit assured, when the camera lamp unit is driven; and
(2) to enable the downsizing and cost reduction of the driving circuit driving at least the camera lamp unit and the illumination unit.

It is an object of the present invention to solve the aforesaid problems and to provide a small-sized, power-saved, convenient mobile terminal device with a camera in which the usage time of a battery is long and desired illumination can be secured even at a dark location.

### SUMMARY OF THE INVENTION

In order to solve the aforesaid problems, an illumination control technology for a mobile terminal device with camera according to the present invention is basically configured such that:
(1) during photographing, when the driving power of the camera light unit for illuminating an object is increased, driving power for an illumination unit for illuminating a display is decreased so that the increase of the total power consumption of the camera light unit and illumination unit can be minimized; and
(2) the camera lamp unit and illumination unit are driven by sharing a power supply unit.

Thus, downsizing and cost reduction of a driving circuit can be achieved. More specifically, the present invention provides a mobile terminal device, a illumination control method thereof and a program for controlling an illumination, each of which includes the technology stated above as a basic constituent requirement.

### BRIEF DESCRIPTION OF THE DRAWINGS

FIG. 1 is a diagram of a configuration example of a mobile terminal device according to an embodiment of the present invention;

FIG. 2 is a diagram of a configuration example of an illumination system in the device of FIG. 1;

FIG. 3 is a diagram showing an illuminating operation of the illuminating system of the device shown in FIG. 1;

FIG. 4 is a diagram for explaining a driving current value of the illuminating system at the time of still image imaging and moving image imaging; and

FIGS. 5A, 5B, and 5C are diagrams illustrating a driving current for driving the illumination system in FIG. 1.

### DESCRIPTION OF THE PREFERRED EMBODIMENT

Referring now to the drawings, preferred embodiments of the present invention will be described below.

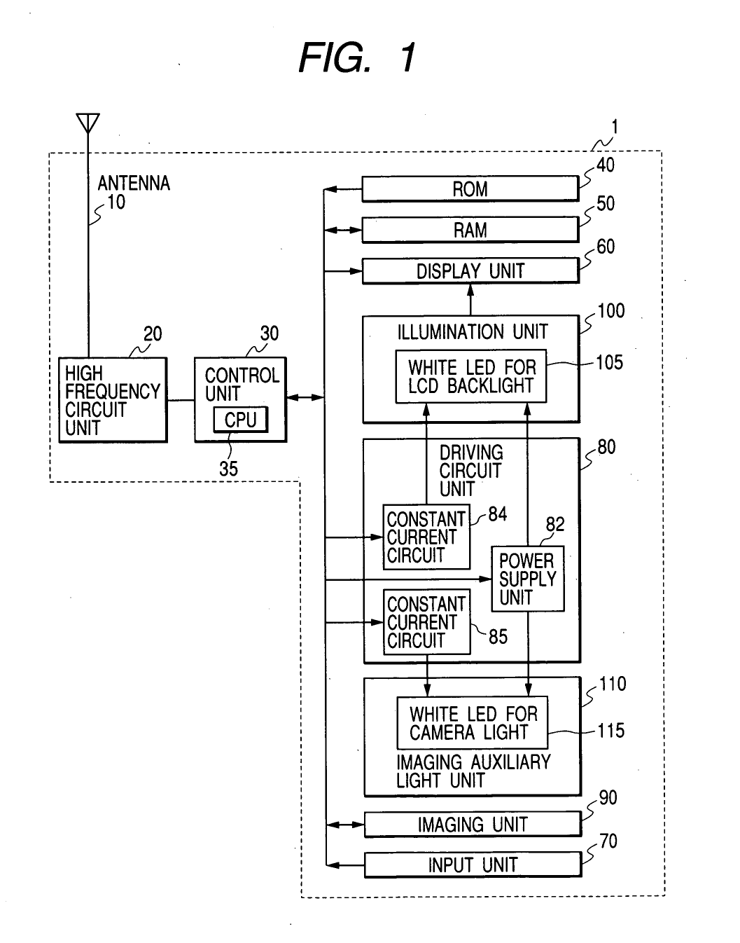

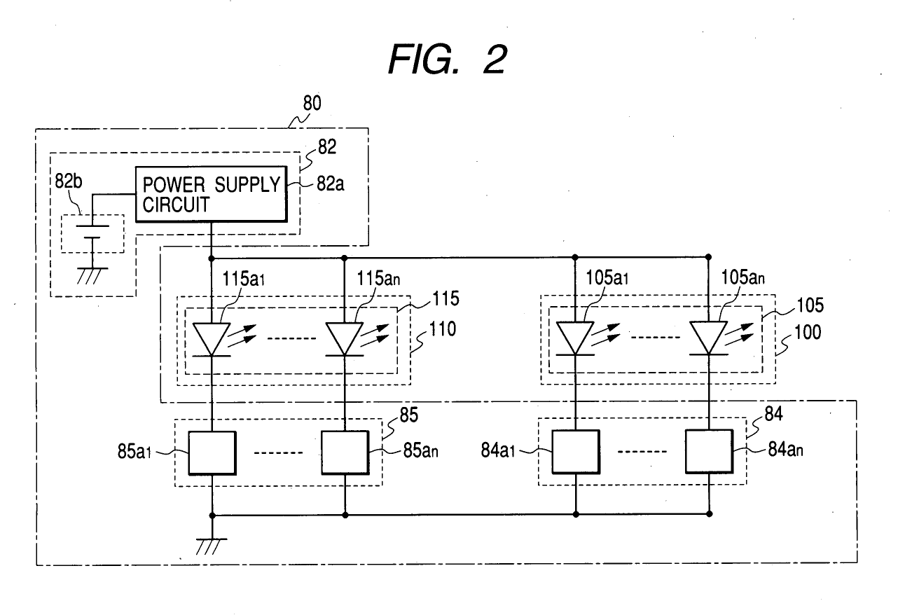

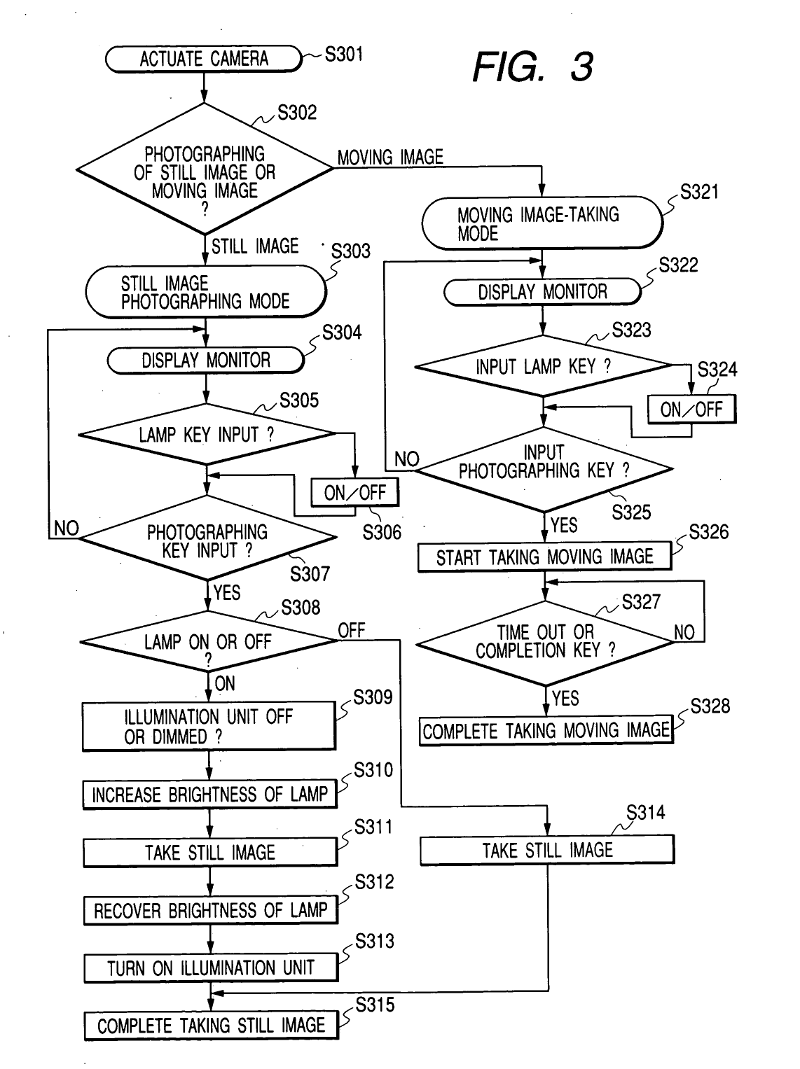

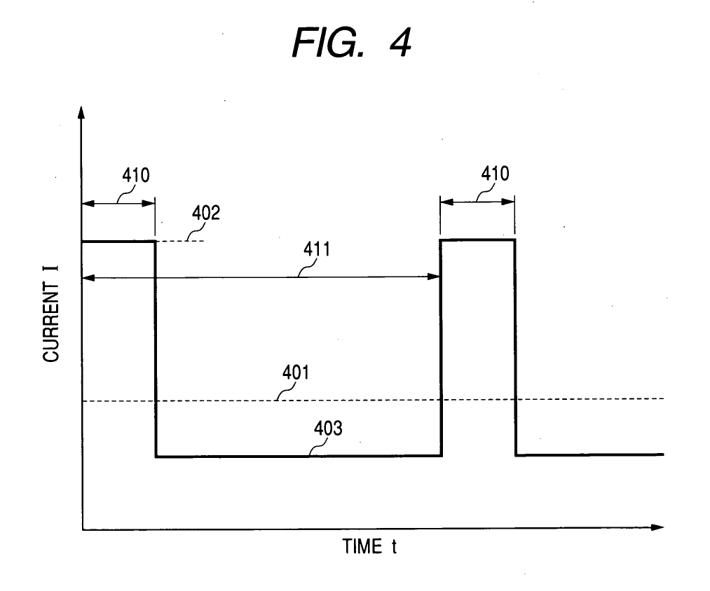

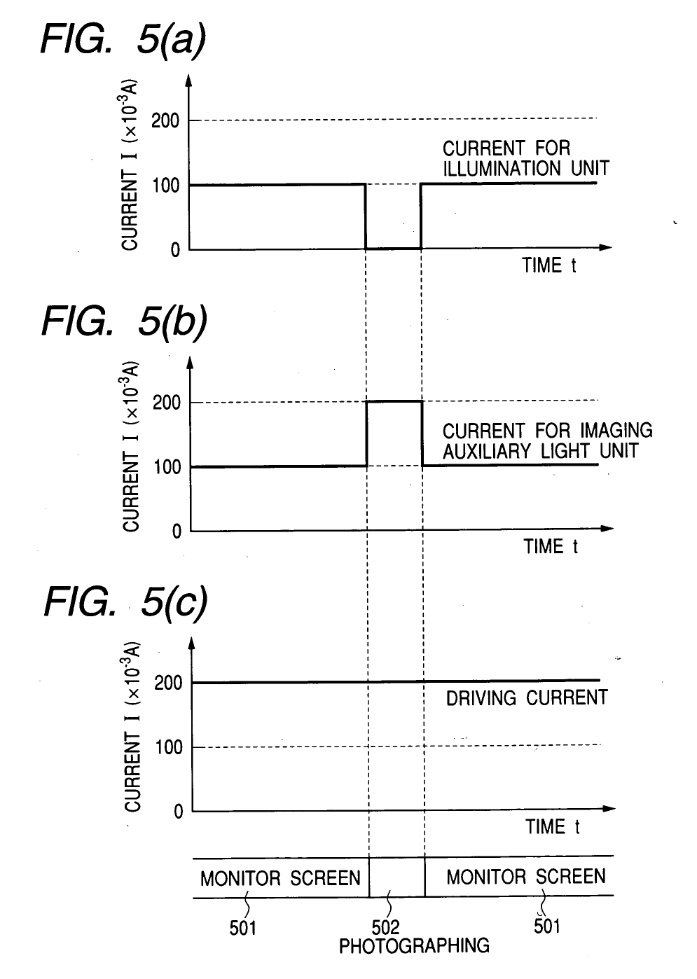

FIGS. 1 to 5 are diagrams for illustrating the embodiments of the present invention: FIG. 1 is a diagram of a configuration example of a mobile terminal device according to an embodiment of the present invention; FIG. 2 is a diagram of a configuration example of an illumination system in the device of FIG. 1; FIG. 3 is a diagram showing an illuminating operation of the illuminating system of the device shown in FIG. 1; FIG. 4 is a diagram for explaining a driving current value of the illuminating system at the time of still image imaging and moving image imaging; and FIGS. 5A, 5B, and 5C are diagrams illustrating a driving current for driving the illumination system in FIG. 1.

In FIG. 1, reference numeral 1 denotes a mobile terminal device with a camera; reference numeral 10 denotes an antenna; reference numeral 20 denotes a high frequency circuit; reference numeral 30 denotes a control unit having a CPU (Central Processing Unit) 35 acting as a control unit for carrying out the entire control of the device; reference numeral 40 denotes a ROM (Read Only Memory) having a system program stored therein; reference numeral 50 denotes a RAM (Random Access Memory) for storing data therein; reference numeral 60 denotes a display unit comprising a liquid crystal display unit (LCD) for displaying character information or image information; reference numeral 100 denotes an illumination unit comprising a white LED for LCD backlight 105 and generating light for illuminating the display unit 60; reference numeral 110 denotes an imaging auxiliary light unit comprising a white LED 115 for a camera light and acting as a camera lamp unit for use in generating light for illuminating an object; reference numeral 80 denotes a driving circuit unit acting as a driving unit for driving with a constant current the illumination unit 100 and imaging auxiliary light unit 110; reference numeral 82 denotes a power supply, within the driving circuit 80, for supplying power to the white LED 105 for the LCD backlight and the white LED for camera light; reference numeral 84 denotes a constant current circuit, within the driving circuit unit 80, for supplying the power of the power supply unit 82 to the white LED 105 for the LCD backlight as a constant current with a specific value; reference numeral 85 denotes also a constant current circuit, within the driving circuit unit 80, for supplying power of the power supply unit 82 to the white LED 115 for a camera lamp as a current with a specific value; reference numeral 90 denotes an imaging unit for photographing the object and outputting the photographed image information; and reference numeral 70 denotes an input unit.

The display unit 60 displays data related to an operation of the control unit 30, an image photographed by the imaging unit 90, still and moving image data stored in ROM 40 or RAM 50, and the like. The imaging unit 90 is composed of a CMOS. (Complementary Metal Oxide Semiconductor) camera or CCD (Charge Coupled Device) camera. The input unit 70 has an input key to enable a user to perform a key inputting operation. When a camera function of the mobile terminal device 1 is used, the user performs imaging-key inputting for an operation starting-up the imaging unit 90, turning-on or turning-off of the imaging auxiliary light unit 110 and getting an image through the imaging unit 90 and the like.

The CPU 35 of the control unit 30 controls operations of the display unit 60, driving circuit unit 80, imaging auxiliary light unit 110 and imaging unit 90 on the basis of a system program stored in the ROM 40 and data stored in the RAM 50. In the driving circuit unit 80, the control current circuits 84, 85 are individually controlled by CPU 35 so as to set On/OFF and a driving current value, and the power supply unit 82 is controlled to set ON/OFF.

The power supply unit 82 is shared by driving the white LED for LCD backlight 105 of the illumination unit 100 and driving the white LED for camera light 115 of the imaging auxiliary light unit 110. In addition, the power supply unit 82 includes a voltage-boost means such as a charge pump circuit, a DC-DC converter or the like so as to cope with a case where the battery voltage of the power supply unit 82 or the like is lower than a forward voltage of the white LED. In a case where the battery is used as the power supply, for example, it is assumed that the forward voltage (Vf) of the white LED is about 3.6 V whereas the battery voltage ranges from about 3.3 V to 4.2. Therefore, when the battery voltage is low, the voltage-boost means is operated. In a case where the battery voltage is higher than the forward voltage of the white LED, the battery voltage may be lowered. Alternatively, the white LED may directly be operated by the higher battery voltage as it is. The power of the battery used as a power supply is supplied to the illumination unit 100, imaging auxiliary light unit 11, high-frequency circuit 20, control unit 30, ROM 40, RAM 50 and other internal components of the device.

The white LED for LCD backlight 105 of the illumination unit 100 and the white LED for camera light 115 of the imaging auxiliary light unit 110 are independently driven by the constant current circuits 84, 85, respectively, at the respective values of the driving currents independently set by the CPU 35. That is, the driving current of the set constant current is supplied from the constant current circuit 85 to the white LED for LCD backlight 105 whereas the driving current of the set constant current is supplied from the constant current circuit 85 to the white LED for camera light 115. The set constant current value (the driving current value) may be the same or different from each other between the white LED for LCD backlight 105 and the white LED for camera light 115. The LED 105 for LCD backlight and the white LED for camera light 115 are each composed of a plurality of white LED elements. The number of the plurality of white LED elements may be the same or different from each other between the white LED for LCD backlight 105 and the white LED for camera light 115. In addition, the white LED elements in each of the white LED for LCD backlight 105 and the white LED for camera light 115 may be connected to one another in parallel, in series, or in series-parallel connection. For example, the plurality of white LED elements may be connected in parallel and each of the plurality of white LED elements may be drivable respectively and independently. In this case, the plurality of constant current circuits of the same number as that of the white LED elements are used and one of the constant current circuit units is provided for each of the white LED elements. In the case of the parallel connection, it is possible to set the driving current value for driving the white LED element respectively for each of the constant current circuit unit associated with each of the plurality of white LED elements. It is therefore possible to increase controllability freedom of intensity (brightness) of the light generated at the white LED for LCD backlight 105 or at the white LED for camera light 115. On the other hand, in the case where the plurality of white LED elements are connected in series, it is possible to reduce the number of lines connecting the driving circuit unit 80 and the illumination unit 100 or the number of lines connecting the driving circuit unit 80 and the imaging auxiliary light unit 110. Thus, if the mobile terminal device has a hinge structure between the driving circuit unit 80 and either the illumination unit 100 or the imaging auxiliary light unit 110, it is possible to reduce the number of lines passing through the hinge structure or the number of connecting lines in the hinge structure with the result that simplification of the structure and improvement of reliability can be easily achieved.

At least one white LED element of the plurality of white LED elements may be driven for illumination in the white LED for LCD backlight 105 of the illumination unit 100 or the white LED for camera light 115 of the imaging auxiliary light unit 110. In this case, the CPU 35 sets the power supply unit 82 at an ON state, at least one of the constant current circuits 84, 85, and the driving current value of the white LED element to be driven. On the other hand, inversely, none of the plurality of white LED elements may be driven for illumination (brought into a turned-off state) in each of the white LED for LCD backlight 105 and the white LED for camera light 115. In this case, the CPU 35 sets the common power supply unit 82 at an OFF state and also both the constant current circuits 84, 85 at an OFF-state.

While the white light LED 105 for LCD backlight or the white light LED 115 for camera lamp is kept illuminated, its brightness may be changed. In this case, a set value of the constant current as the driving current for the white light LED 105 is changed. For example, in the case of picking up a still image, while the white LED for camera light 115 is turned ON to illuminate the object, the constant current circuit 84 is turned off to bring the set value of the constant current serving as a driving current for the white LED 105 for the LCD backlight into zero. Alternatively, the set value of the constant current serving as the driving current for the white LED for LCD backlight 105 is lowered while the constant current circuit 84 is turned off, so that the light emitting brightness of the white LED for LCD backlight 105 is decreased. That is, if the driving current or driving power of the white LED for camera light 115 is to be increased, that of the white LED 105 for camera lamp is decreased to a value (including zero) lower than a value at the normal time. Thus, an increase of the driving power in the entire illuminating system including the imaging auxiliary light unit 110 (the white LED for camera light 115) and the illuminating unit 100 (the white LED 105 for backlight) is minimized to provide power saving in the entire device, whereby the power required in the battery of the power supply unit 82 is to be reduced. If the increase of the driving current or driving power of the white LED for camera light 115 is substantially equal to the decrease of the driving current or driving power, an increase in the driving power of the entire illuminating system can substantially be zero. The increase of the driving power or driving current of the white LED for camera light 115 can secure the brightness of the imaging auxiliary light unit 110, whereby the object can be easily photographed as a bright image even in a dark location.

FIG. 2 is a diagram showing a configuration example of the driving circuit unit 80, the illuminating unit 100 and the imaging auxiliary light unit 110. The driving circuit unit 80 is configured to supply a driving current to the illuminating unit 100 and imaging auxiliary light unit 110 by sharing the power supply unit 82.

In FIG. 2, reference symbol 82a denotes a power supply circuit constituting the power supply unit 82; reference symbol 82b denotes a battery cell similarly constituting the power supply unit 82; reference symbol 105ₐ₁, . . . , 105ₐₙ denote a plurality of white LED elements constituting the white LED for LCD backlight 105 of the illuminating unit 100; reference symbols 115ₐ₁, . . . , 115ₐₙ denote a plurality of white LED elements constituting the white LED for camera light 115 of the imaging auxiliary light unit 110; reference symbols 84ₐ₁, . . . , 84ₐₙ denote constant current circuit units for supplying a constant current serving as the driving current to the white LED elements 105ₐ₁, . . . , 105ₐₙ, respectively; and reference symbols 85ₐ₁, . . . , 85ₐₙ denote constant current circuit units for supplying a constant current serving as the driving current to the white LED elements 115ₐ₁, . . . , 115ₐₙ, respectively. The power supply circuit 82a is enclosed in one package in the embodiment.

In the embodiment, the white LED elements 105ₐ₁, . . . , 105ₐₙ are connected in parallel and the white LED elements 115ₐ₁, . . . , 115ₐₙ are also connected in parallel. The number of the white LED elements 105ₐ₁, . . . , 105ₐₙ may be equal to or different from that of the white LED elements 115ₐ₁, . . . , 115ₐₙ. The power supply circuit 82a is provided with a voltage boost means such as a charge pump circuit or a DC-DC converter. Thus, if the forward voltage of the battery 82b is lower than that of the white LED, the power supply circuit 82a can stably supply a constant current of the driving current to the white LED elements 105ₐ₁, . . . , 105ₐₙ or the white LED elements 115ₐ₁, . . . , 115ₐₙ through the constant current circuit units 84ₐ₁, . . . , 84ₐₙ and the constant current circuit units 85ₐ₁, . . . 85ₐₙ, respectively.

The power supply circuit 82a, constant current circuit 84 and constant current circuit 85 are controlled independently from each other by the CPU 35 in the control unit 30. The power supply circuit 82a is controlled by the CPU 35 to be turned ON or OFF and to be connected to the voltage boost means. Each of the constant current circuits 84, 85 is controlled to be turned ON or OFF and to create a value of the constant current. When the constant current circuit 84 is turned ON, each of the constant current circuit units 84ₐ₁, . . . , 84ₐₙ is controlled respectively to create a constant current with a value set by the CPU 35 as a driving current and supplies it to the white LED elements 105ₐ₁, . . . , 105ₐₙ of the white LED 105 for the LCD backlight. In addition, when the constant current circuit 85 is turned ON, each of the constant current circuit units 85ₐ₁, . . . , 85ₐₙ is controlled respectively to create a constant current of a value set by the CPU 35 as a driving current and supplies it to the white LED elements 115ₐ₁, . . . , 115ₐₙ of the white LED for LCD backlight 105.

For example, in the case of taking a still image, the constant current circuit 85 is turned on to control the constant current circuit units 85ₐ₁, . . . , 85ₐₙ so as to create the constant current set to a value high enough to illuminate the object in at least an instantaneous period of photographing. Then, the constant current is supplied to the white LED elements 115ₐ₁, . . . , 115ₐₙ of the white LED for camera light 115 to allow each of the white LED elements to emit light with brightness corresponding to the current and this light is injected as an illuminating light to the object. At this time, the constant current circuit 84 is turned into an OFF state or ON state in which the constant current value is lower than that of the normal state. When the constant current circuit 84 is in the OFF state, supply of the driving current (a constant current) to each of the white LED elements 105ₐ₁, . . . , 105ₐₙ of the white LED for LCD backlight 105 is stopped to cause each of the white LED elements 105ₐ₁, . . . , 105ₐₙ not to emit any light. In addition, in the ON state in which the constant current value is lower than that of the normal state, the driving current (the constant current) with a value lower than that of the normal state is supplied to each of the white LED elements 105ₐ₁, . . . , 105ₐₙ to cause each of the white LED elements 105ₐ₁, . . . , 105ₐₙ to emit light with brightness corresponding to the low level current and then the emitted light is injected toward the display unit 60 as light for the backlight. If the total power of power consumption in the illumination unit 100 or white LED for LCD backlight 105 and power consumption in the imaging auxiliary light unit 110 or white LED for camera light 115 is constant, as the driving current of the white LED for camera light 115 is reduced, the driving current of the white LED for camera light 115 can be increased and light emitting brightness of the white LED for camera light 115 can be increased. Incidentally, when the white LED elements 105ₐ₁, . . . , 105ₐₙ are to be controlled, the respective values of the constant currents outputted from the white LED elements may be made equal to each other. Alternatively, part of the white LED elements may output a constant current with a value different from those of the other element. The same holds true for the control of the white LED elements 115ₐ₁, . . . , 115ₐₙ.

In FIG. 2, the driving circuit unit 80 is configured such that the power supply unit 82 is shared by at least the illuminating unit 100 and the imaging auxiliary light unit 110, so that it can be downsized and reduced in cost. In addition, the entire device can be downsized and reduced in cost. The power supply circuit 82a is enclosed in one package in the power supply unit 82, thereby further enhancing the downsizing and cost reduction.

FIG. 3 is a diagram explaining an illuminating operation of an illumination system in the device shown in FIG. 1. The constitutional elements in FIG. 1 used in the description of FIG. 3 are denoted by the same reference symbols as those shown in FIG. 1. The same holds true for FIGS. 4 and 5.

In FIG. 3, the following steps are carried out.

(1) When a key inputting operation is carried out for actuating the imaging unit 90 (a camera) of the mobile terminal device, the CPU 35 detects the operation and actuates the imaging unit 90 (hereinafter referred to as camera actuation) (step S301).

(2) The imaging mode is switched to a still image-taking mode or a moving image-taking mode in accordance with a user's judgment (step S302).

(3) When the switching results in the still image-taking mode, the CPU 35 detects it and sets the device to the still image-taking mode (step S303).

(4) The control unit 30 (CPU 35) displays as needed the image data taken from the imaging unit 90 on the display unit 60 as a monitor screen (step S304).

(5) If the device is used at its surrounding dark location, for example, in actuating the camera, according to the user's judgment, a light key operation is carried out in which the white LED for camera light 115 of the imaging auxiliary light unit 110 is driven to generate light for illumination of the still object (step S305).

(6) The CPU 35 detects the aforesaid light key inputting operation, and controls the constant current circuit 85 in the driving circuit 80 to turn on or off the white LED for the camera light 115 of the imaging auxiliary light unit 110 (step S305). When the LED 115 is to be turned on, the constant current circuit 85 is turned on to supply power from the power supply unit 82 to the white LED for camera light 115 as a predetermined driving current of constant current through the constant current circuit 85. The LED 115 is to be turned off to stop the supply of the driving current to the white LED for camera light 115 (step S306).

(7) The imaging key inputting operation is carried out and the CPU 35 detects this operation (step S307).

(8) The CPU 35 detects a state of the white LED for camera light 115 of the imaging auxiliary light unit 110 and judges whether the white LED for camera light 115 is in a turned-on or turned-off state (step S308).

(9) If the white LED for camera light 115 is in the turned-on state as a result of the judgment of step S308, the CPU 35 controls the constant current circuit 84 and reduces the value of the current supplied as the driving current of constant current from the power supply unit 82 to the white LED for LCD backlight 105 of the illumination unit 100 to zero or a value lower than that of the normal time. Thus, the white LED for LCD backlight 105 is turned off or dimmed (=decreasing intensity of light)(step S309). In the case where the LCD is dimmed, the constant current circuit 84 is turned and a set value of the driving current in the constant current circuit 84 is reduced to a value lower than a normal value.

(10) The CPU 35 controls the constant current circuit 85 to increase the constant current acting as the driving current of the white LED for camera light 115 of the imaging auxiliary light unit 110, thereby increasing its light-emitting brightness (that is, increasing intensity of illuminating light)(step S310). At this time, the increase of the driving current of the white LED for camera light 115 may be made substantially equal to the decrease of the driving current of the white LED for LCD backlight 105 in step S309.

(11) Taking a still image is carried out (step S311). At this time, the CPU 35 stores the still image data taken from the imaging unit 90 in the RAM 50.

(12) Upon completion of the still imaging, the CPU 35 detects it, and decreases the driving current for the white LED for camera light 115 of the imaging auxiliary unit 110 to a level before step S310, thereby returning light emitting brightness of the white LED 115 to a level before the brightness has been increased (=reducing)(step S312).

(13) The CPU 35 returns the driving current of the white LED 106 for LCD backlight of the illuminating unit 100 to the level before reduced or reduced to zero in step S309 and returns the brightness of the display unit 60 to the original level (step S313).

(14) A series of operations for imaging a still image is finished (a step S315).

(15) In the case where the imaging mode of the device is switched to the moving image-taking mode in step S302, the CPU 35 detects this switching and brings the device into the moving image taking mode (step S321).

(16) The control unit 30 (CPU 35) displays as needed the moving image data taken from the imaging unit 90 on the display unit 60 as a monitor screen (step S322).

(17) When the device is used at a surrounding dark location, the light key inputting operation is carried out in which the white LED for camera light 115 in the imaging auxiliary light unit 110 is driven to generate the light (step S323).

(18) The CPU 35 detects the aforesaid lamp key inputting operation, controls the constant current circuit 85 in the driving circuit unit 80, and controls supply of the driving current for the white LED for camera light 115, thereby turning on (light emitting) or turning off the white LED 115 (step 324).

(19) The imaging key inputting operation is carried out and the CPU 35 detects it (step S325).

(20) The CPU 35 starts taking a moving image (step S326).

(21) The CPU 35 allows the moving image to be taken until the imaging finish key operation is detected or time-out is done (a step S327).

(22) Taking a moving image is finished (step S328).

(23) In addition, in the case where the white LED for camera light 115 is in a turned-off state as a result of the judgment in step S308, the device takes the still image as it is (a step S314) and subsequently taking the still image is finished.

A series of operations of steps S308, S309, S310, S311, S312 and S313, operations of steps S303 and S314 or a series of operations of steps S303, S310, S309, S311, S312 and S313 in FIG. 3 are implemented through its procedure operated by the CPU 35 in accordance with a preset program. The program is stored in the ROM 40 as a system program.

FIG. 4 is a diagram for explaining driving current values of the white LED 115 (FIG. 1) for camera lamp at the time of taking the still image and taking the moving image.

In FIG. 4, reference numeral 401 denotes a level of the driving current value supplied continuously to the white LED for camera light 115 when the moving image is taken. Reference numeral 402 denotes a level of the driving current value supplied instantaneously to the white LED for camera light 115 when the still image is taken. Reference numeral 403 denotes a level of the driving current value supplied to the white LED for camera light 115 at the time of the monitor display in the still image-taking mode. Reference numeral 410 denotes a period of time for supplying the driving current, namely, a period of time for turning on the white LED 115 when the still image is taken. Reference numeral 411 denotes a period of imaging (namely, a period of turning on the white LED 115) when the still image is taken periodically. Incidentally, the level denoted by reference numeral 403 may be zero. When the moving image is taken, it is necessary to illuminate the object for a long period of time in order to adapt to the motion of the object. For this reason, the driving current (current level 401) having a decreased current value level is continuously supplied to the white LED for camera light 115 to continuously emit light for illumination. In contrast, when the still image is taken, it is possible to take a picture by illuminating instantaneously the object because the object shows no motion at all. Accordingly, the driving current (current level 402) having an increased current value level is supplied instantaneously (a period of time for power supply 410) to the white LED for camera light 115 to emit light for illumination. Further, the driving current is the sum of the driving currents supplied to the plurality of white LED elements in the case where the white LED for camera light 115 is configured such that the plurality of white LED elements are connected in parallel.

For example, for the instantaneous current level 402, the period of time of current supply is short, and therefore, it is possible to set the instantaneous current level 402 at a level substantially higher than that of the continuous current level 401. The current (electrical power) required for the power supply unit 82 is the sum of the current (electrical power) supplied to the white LED for camera light 115 as the constant driving current and the current (electrical power) supplied to the white LED 106 for LCD backlight as the constant driving current. Accordingly, in the present invention, when a driving current is supplied to the white LED for camera light 115, the level of the driving current supplied to the white LED for LCD backlight 105 is decreased to minimize the total value of both the currents, thereby increasing the driving current value of the white LED for camera light 115 as much as possible. As regards the current level 402, the maximum forward current of the white LED element is defined in general by the following conditions: the level of a current continuously supplied to the white LED element at the normal time; respective levels of the currents supplied increasingly and decreasingly to the white LED element; a lighting time caused by the increasingly supplied current; and a duty between the lighting time caused by the increasingly supplied current and a lighting period of time. Incidentally, the level of the decreasingly supplied current may be zero in some cases.

FIGS. 5A to 5c are diagrams for explaining a driving current for use in driving the imaging auxiliary light unit 110 and the illuminating unit 100.

FIG. 5A shows a driving current for the illumination unit 100; FIG. 5B shows a driving current for the imaging auxiliary light unit 110; and FIG. 5C shows the sum of both the driving currents supplied from the power supply unit 82. In addition, reference numeral 501 denotes a period of time for the displaying of the monitor screen and reference numeral 502 denotes a period of time for imaging. In the present embodiment, each of the driving current fort the illumination unit 100 and the driving current for the imaging auxiliary light unit 110 in the period of time for the continuous display 501 is 100×10⁻³ A, whereas the driving current for the illumination unit 100 is zero and the driving current for the imaging auxiliary light unit 110 in the period of time for instantaneous imaging 502 is 200×10⁻³ A. That is, the increase of the driving current (200×10⁻³ A-100×10⁻³ A=100×10⁻³ A) for the imaging auxiliary light unit 110 in the period of imaging 502 is decreased by the amount of the driving current for the illumination unit 100. As a result, the sum of the driving currents for the illumination unit 100 and the imaging auxiliary light unit 110 becomes 200×10⁻³ A also in the period of imaging 502 which is the same value as that in the period of displaying 100. Thus, the total power consumption for both the units is minimized in the period of imaging.

In the embodiment of the present invention, when the imaging auxiliary light unit 110 is driven in the mobile terminal device with a camera, it is possible to minimize the entire driving power for the imaging auxiliary light unit 110 and illumination unit 100 with the light-emitting brightness of the imaging auxiliary light unit 110 secured, thereby reducing the power consumption of the device. In addition, it is possible to reduce the size and cost of the driving circuit unit 80 and the mobile terminal device having the same.

Incidentally, although the configuration of the present embodiment has been described in which a driving current value for the white LED for camera light 115 of the imaging auxiliary light unit 110 and a driving current value for the white LED for LCD backlight 105 of the illumination unit 100 are made variable when the still image is taken, the present invention is not limited to this configuration. Both the driving current values may be also controlled at the time of taking a moving image. In addition, the display unit 60 may be provided with a plurality of LCDs. In this case, the light of the part of the LCDs may be controlled with the driving current value of the white LED for LCD backlight 105 in the illumination unit 100. In addition, in the embodiment of the present invention, although the plurality of LED elements acting as either the white LED for camera light 115 or the white LED for LCD backlight 105 are the white LED elements for emitting white light, the present invention is not limited to this configuration. The plurality of LED elements may be elements emitting color lights such as red (R), green (G) or blue (B). Further, light emitting means different from the LED element may be used in the illumination unit 100 or imaging auxiliary light unit 110. In addition, the illumination unit 100 is not limited to the backlight type light emitting means, but a front-lamp type light emitting means may be used. Further, the displaying unit 60 may comprise a means other than the LCD.

In accordance with the present invention, it becomes possible to provide a small-sized, power-saving, convenient mobile terminal device with a camera.

1. A mobile terminal device with a camera comprising:
a camera lamp unit for generating light for illuminating an object;
a display unit for displaying image information;
an illumination unit for generating light illuminating said display unit; and
a driving unit for driving said camera lamp unit and said illumination unit by sharing a power supply.

2. A mobile terminal device with a camera comprising:
a camera lamp unit for generating light for illuminating an object;
a display unit for displaying image information;
an illumination unit for generating light illuminating said display unit; and
a driving unit for driving said camera lamp unit and said illumination unit respectively;
wherein illumination with said camera lamp unit and illumination with said illumination unit are controlled respectively.

3. A mobile terminal device with a camera comprising:
a camera lamp unit for generating light for illuminating an object;
a display unit for displaying image information;
an illumination unit for generating light illuminating said display unit; and
a driving unit for driving said camera lamp unit and said illumination unit by sharing a power supply unit and for respectively changing respective driving states of said camera lamp unit and said illumination unit; and
a control unit for controlling said display unit and said driving unit;
wherein driving power for said illumination unit is decreased when driving power for said camera lamp unit is increased.

4. A mobile terminal device with a camera comprising:
a camera lamp unit for generating light for illuminating an object;
a display unit for displaying image information;
an illumination unit for generating light illuminating said display unit; and
a driving unit for driving said camera lamp unit and said illumination unit by sharing a power supply unit and for respectively changing respective driving states of said camera lamp unit and said illumination unit; and
a control unit for detecting whether light of said camera lamp unit is in an ON state or OFF state and controlling said driving unit based on a result of the detection;
wherein when the light from said camera lamp unit is in the ON state, said control unit controls said driving unit during photographing operation so that intensity of the light from said illumination unit may be decreased and intensity of the light from said camera lamp unit may be increased.

5. A mobile terminal device with a camera according to claim 1, wherein said driving unit is enclosed in one package.

6. A mobile terminal device with a camera according to claim 1, wherein light of each of said camera lamp unit and said illumination unit is generated by an LED.

7. A mobile terminal device with a camera according to claim 1, wherein when said camera lamp unit generates light, said driving unit reduces the driving current for said illumination unit to a level lower than a normal time or to zero.

8. A mobile terminal device with a camera according to claim 1, wherein when said driving unit increases a driving current for said camera lamp unit so as to increase light thereof and as decreases a driving current for said illumination unit so as to decrease light therefor, an increase of said driving current or driving power for said camera lamp unit is made substantially equal to a decrease of said driving current or driving power for said illumination unit.

9. A method for controlling illumination of a mobile terminal device with a camera at time of photographing, comprising:
a first step in which, while a device mode is brought into a photographing mode, a driving current value of an illumination unit for illuminating a display unit is reduced to a level lower than that in a normal time or to zero so as to decrease intensity of generating light, whereas a driving current value of a camera light unit for illuminating an object is increased so as to increase intensity of generating light; and
a second step in which after the object is photographed, completion of the photographing is detected, the respective driving current values of said camera lamp unit and said illumination unit are returned to levels before the photographing so as to return the intensity of the generated light to the original levels.

10. A program for controlling illumination of a mobile terminal device with a camera at the time of photographing, said program allowing a CPU to perform:
a procedure in which, while a device mode is brought into a photographing mode, a driving current value of an illumination unit for illuminating a display unit is reduced to a level lower than that in a normal time or to zero so as to decrease intensity of generating light, whereas a driving current value of a camera light unit for illuminating an object is increased so as to increase intensity of generating light; and
a procedure in which, after the object is photographed, completion of the photographing is detected, the respective driving current values of said camera lamp unit and said illumination unit are returned to levels before the photographing so as to return the intensity of the generated light to the original levels.
